(19) United States
(12) Patent Application Publication
(10) Pub. No.: US 2008/0310708 A1
(43) Pub. Date: Dec. 18, 2008

(54) Method for Improving Image Viewing Properties of an Image

(75) Inventors: Steven Lobregt, Eindhoven (NL); Cornelis Pieter Visser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,416

(22) PCT Filed: Dec. 13, 2006
(86) PCT No.: PCT/IB2006/054816

§ 371 Date: Jun. 20, 2008

(30) Foreign Application Priority Data
Dec. 21, 2005 (EP) 05112621.7

(51) Int. Cl. G06K 9/00

(52) U.S. Cl. 382/154; 382/128

(57) ABSTRACT

An image processing method for improving image viewing properties of a digital image is disclosed. The method comprises converting a value of a property of at least one pixel of the image into a display value of the at least one pixel of the image by means of a parameterized function, wherein the parameterized function is location dependent with reference to the location of said at least one pixel of the image, thus creating locally optimized image viewing properties of the image.

This invention pertains in general to the field of image processing. More particularly the invention relates to the translation from a pixel value to a display value in order to optimize viewing properties of an image with regard to a display device.

A look up table (LUT) is generally defined as a table which converts an image pixel value into a display pixel value, e.g. presented on a computer monitor.

Usually, the number of gray or color values in an image is larger than the number of values that may be displayed on a display device such as a monitor, or printed by a printing device. A LUT is then used to select a range of values, and to stretch or compress this range so that it optimally fits the range of values that can be displayed or printed. This is a very common procedure within the art of image analysis; the simplest implementation is a linear LUT. A more sophisticated solution is a non-linear LUT, for instance to stretch lower values more than higher values. The LUT may also be adapted (automatically) to the image content, for instance by deriving the shape from the histogram of values in the image. If the cumulative histogram is used for the LUT shape, each value will get a share of the display range proportional to the number of pixels that have that value, which is called histogram equalization.

For grayvalue images, a LUT is used to translate pixel/voxel values into a range of grayvalues that optimally fit the capabilities of the display or printing device. However, LUT's are not only used for grayvalue optimization, but for example also for optimization of color image displays. For color images, in general a number of different LUT's are used, one for each color component, to translate pixel/voxel color component values into a range of color component values that optimally fit the capabilities of the display or printing device.

In practice, the person who views these images will concentrate on one image area and optimize the LUT for said area, and then move to another image area and readjust the LUT setting for that other image area, and so on.

Another solution is to pre-process the image so that contrast and brightness becomes more equal throughout the whole image. After that, the image may be viewed with one setting that is more or less optimal for the whole image. Pre-processing introduces an extra step in the process from pixel value to display value, and may introduce extra inaccuracy. The user will be required during viewing to concentrate on particular structures or value ranges in the image, e.g. optimizing the vessel structure visibility or optimally displaying the lower values in the image. Depending on the type of application, the user may want to be able to modify the settings or adapt the goal of the viewing procedure. This means that the pre-processing cannot be done one single time in advance before the actual use of the image for viewing.

A publication relating to LUTs for improving digital images is disclosed in U.S. Pat. No. 6,205,198. U.S. Pat. No. 6,205,198 describes a way of improving an entire image by using pixel values in a region to index entries in said region in a LUT which contains new pixels values. By repeating the step for each region of the image eventually an entire improved image is achieved.

A consequence of concentrating on one image area at a time and readjusting the LUT when moving to another area is, that the user will not be able to have a complete overview of the whole image with optimal LUT settings at the same time. Moreover, the contrast/brightness variation in general is not constant over a sub-area of the image, which means that even inside an area for which the LUT is set optimal, there will be parts of the area for which the LUT is not optimal.

Some image acquisition protocols in X-ray and MRI deliver image data which has no fixed value for equal tissue over the whole image. Contrast and/or brightness may vary over the image. As a consequence, in order to optimally view the same tissue in different parts of the image, for instance contrasted vessels, we would need to apply different LUTs at different locations within the image. The variation in contrast/brightness is in general continuous, i.e. there is not a limited number of LUTs which can be defined for a limited number of image areas, by which the entire image will be displayed optimally.

The LUT operation is always defined for and applied to the image as a whole. If it is modified, automatically or in interactively, the modification applies to the whole image. This means that it is often difficult to view all parts of the entire image in optimal visual resolution. When optimizing a LUT for one area of an image, resultantly all other areas of said image are affected, often resulting in poorer visibility of said other areas.

Hitherto, technical solutions relating to LUTs utilized on digital images for improving the viewing resolution of said digital images have been limited to parts or regions of an image of interest in order to achieve sufficient visual resolution. The desire for a user to be able of viewing and modifying the visual resolution of an entire image simultaneously, without having to process selected regions of the image separately, has until now not been solved.

Hence, an improved location dependent LUT, comprising image pixel location information, would be advantageous allowing for increased image resolution, flexibility and cost-effectiveness.

Accordingly, the present invention preferably seeks to mitigate, alleviate or eliminate one or more of the above-identified deficiencies in the art and disadvantages singly or in any combination and solves at least the above-mentioned problems by providing a method, an apparatus, and a computer-readable medium, according to the appended patent claims.

According to one aspect of the invention, an image processing method for improving image viewing properties of a digital image is provided. The method comprises converting a value of a property of at least one pixel of the image into a display value of the at least one pixel of the image by means of a parameterized function, wherein the parameterized function is location dependent with reference to the location of said at least one pixel of the image, thus creating locally optimized image viewing properties of the image.

According to another aspect of the invention, an image processing apparatus is provided. The apparatus, is adapted to improve image viewing properties of a digital image and comprises means for converting a value of a property of at least one pixel of the image into a display value of the at least one pixel of the image by means of a parameterized function, wherein the parameterized function is location dependent with reference to the location of said at least one pixel of the image, thus creating locally optimized image viewing properties of the image.

According to an embodiment the apparatus is a medical workstation.

According to a further aspect of the invention, a computer-readable medium having embodied thereon an image processing computer program for processing by a computer is provided. The computer program comprises code segments for improving image viewing properties of a digital image, and comprises a first code segment for converting a value of a property of at least one pixel of the image into a display value of the at least one pixel of the image by means of a parameterized function, wherein the parameterized function is location dependent with reference to the location of said at least one pixel of the image, creating locally optimized image viewing properties of the image.

The present invention introduces a new technical solution for improving an image significantly based on a location dependent LUT comprising image pixel location information. Some images require different LUT settings for different image areas to be viewed optimally. According to some embodiments of the invention, locally optimized LUT are provided, that use not only the pixel/voxel value as an input but also the pixel/voxel coordinates as parameters. Simple user interaction may be implemented to point at a number of image locations for which the optimal LUT is determined automatically, while the parameterization provides a smoothly varying LUT function over the whole image. According to some embodiments of present invention a location-dependent LUT is applied, allowing a user to view an entire image with optimal contrast, brightness, etc. Semi-automatic definition of the LUT is performed according to certain embodiments of the invention and requires only a minimum of user interaction.

These and other aspects, features and advantages of which the invention is capable of will be apparent and elucidated from the following description of embodiments of the present invention, reference being made to the accompanying drawings, in which:

FIG. 1 is a schematic illustration of a linear parameterized function;

FIG. 2 is a schematic illustration of a non-linear parameterized function;

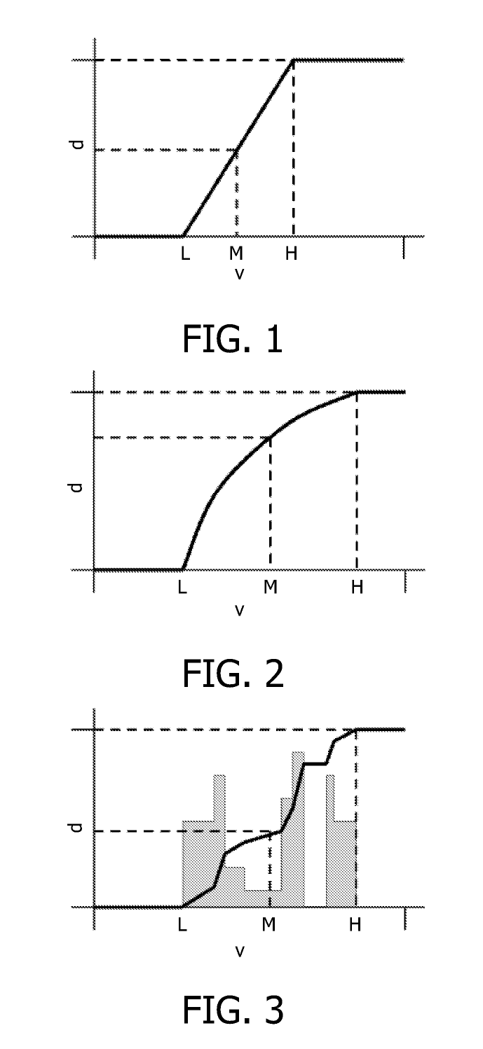

FIG. 3 is a schematic illustration of a LUT shape for histogram equalization;

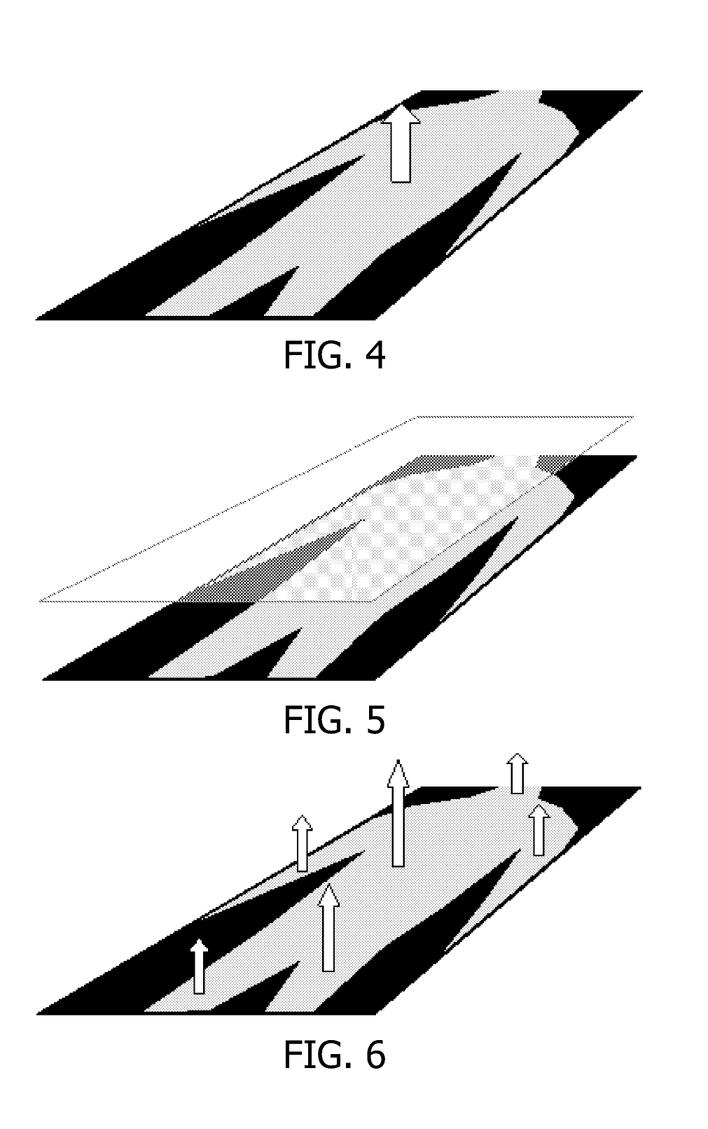

FIG. 4 is a schematic illustration of a globally parameterized function for an entire image;

FIG. 5 is a schematic illustration of a globally parameterized function that is plane with constant height for all pixels of the image according to FIG. 4;

FIG. 6 is a schematic illustration of showing selected pixels, which are used to create a location dependent parameterized function according to an embodiment of the present invention;

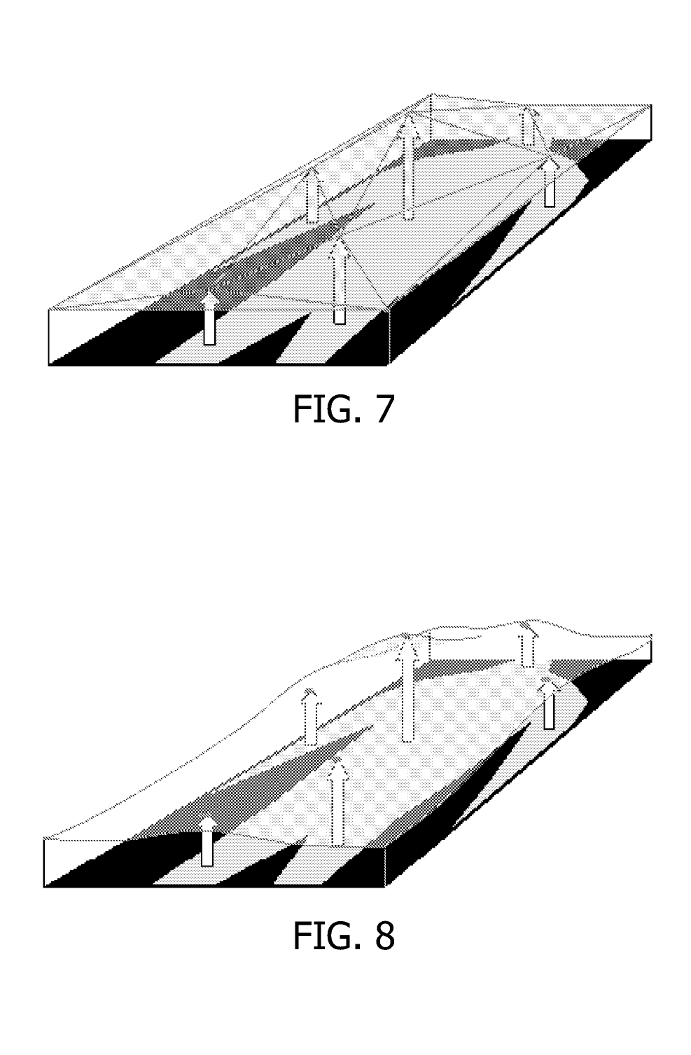

FIG. 7 is a schematic illustration depicting a location dependent parameterized function, i.e. a plane consisting of flat triangulated shapes with the corners at the position of the selected pixels of FIG. 6;

FIG. 8 is a schematic illustration of another smoothly interpolated parameterized function of the present invention;

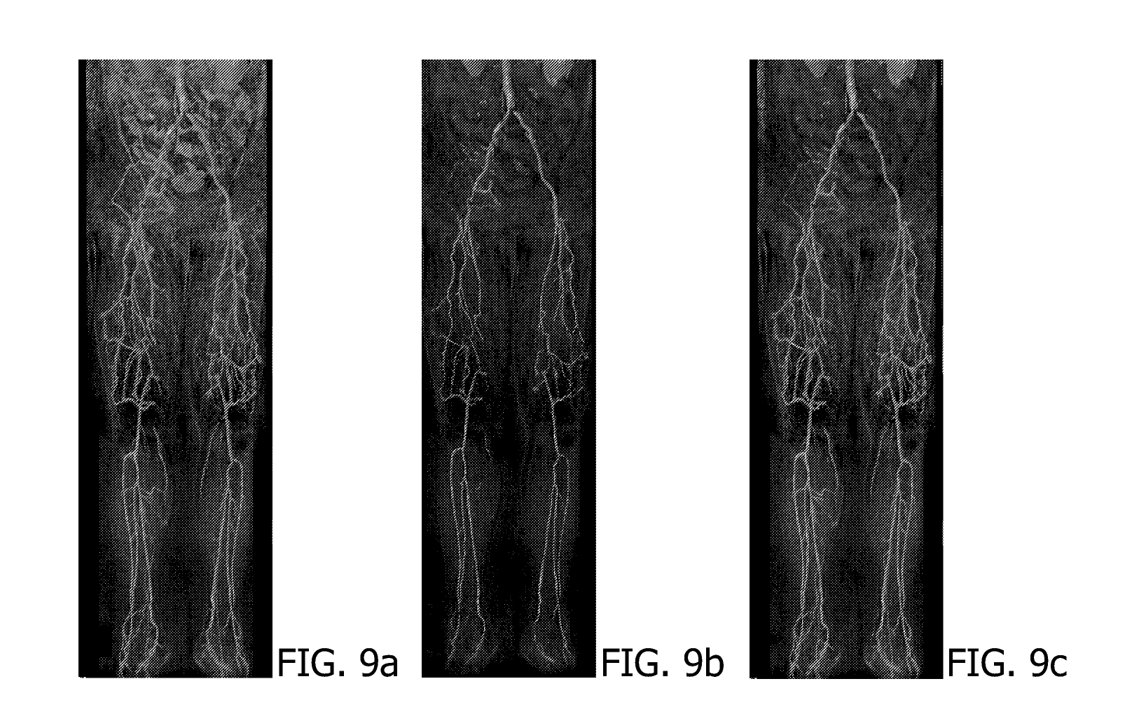

FIG. 9a is an exemplary image showing a human vessels structure processed with a globally parameterized function optimized for viewing the vessels in the lower limbs;

FIG. 9b is an exemplary image showing the image of FIG. 9a processed with a globally parameterized function optimized for viewing the vessels in the abdomen; and

FIG. 9c is an exemplary image showing the image of FIG. 9a processed with a location dependent parameterized function according to an embodiment of the present invention.

The present invention may be applied in all applications where a LUT is used for mapping the range of grayvalues contained in an image to a range of grayvalues suitable to be presented on a display device (monitor) or to be printed as a hardcopy by a printing device.

The following description of embodiments is focused on three-dimensional cases, i.e. equations and expressions relate to 3D datasets (x,y,z). However, the invention is not limited to this specific case, and the explanations given below are merely to be regarded as an example. Other embodiments are applicable to data of other dimensions, like two-dimensional datasets (x,y), four-dimensional (three dimensions plus time) datasets, or datasets having any dimension.

A common 3D LUT operation is written, according to eqn. 1, where v=I(x, y, z) is the value of pixel/voxel with coordinates (x, y, z), ƒ(v) is a function describing the mapping of v to d, which is the display value for the element at (x, y, z)

d(x,y,z)=f(v) (eqn. 1)

Normally a LUT is defined as a single lookup table that is used for the whole image to translate a pixel value to a display value. FIG. 1 illustrates a simple linear LUT, in which pixel value v is assumed to range from 0 to 4095 and display value d ranges from 0 to 255. L and H are parameters for translating pixel value v to display value d, and they are global parameters to the image i.e. the same value for the whole image. If we define L, the lowest accepted pixel value, and H, the highest accepted pixel value, then d is given by:

$$\begin{matrix}d ( x , y , z ) = f ( v ) = 0 , & for v <= L \\ d ( x , y , z ) = 255 \cdot \frac{v ( x , y , z ) - L}{H - L} , & for L < v < H \\ d ( x , y , z ) = f ( v ) = 255 , & for v >= H \\ d ( x , y , z ) = f ( v ) = 255 / 2 , & for v = M = ( H + L ) / 2\end{matrix}$$

Every pixel value v(x,y,z) is translated to a display value d(x,y,x), but in order not to calculate d(x,y,z) each time a new pixel value is desired, the calculations of d(x,y,z) are only done once and the results stored in a LUT, a lookup table described by the function ƒ(v), with a length equal to the number of possible pixel values. This is possible because d(x, y, z)=ƒ(v) depends on the value of v only. The index of the LUT is the pixel value v(x,y,z), and the value stored in the LUT, which is returned during a lookup operation is the display value d(x, y, z)=ƒ(v). L and/or H may be outside the actual pixel value range. A LUT does not have to be linear, but may have other shapes, in which case ƒ(M) may not have the value 255/2, and M may even be of little importance.

Other ways of describing ƒ(v) is shown in FIG. 2, illustrating a non linear LUT and FIG. 3, illustrating a LUT shape for histogram equalization.

The common LUT operation is defined for and applied to the image as a whole. If it is modified, automatically or interactively, the modification applies to the whole image.

The prior art method of pre-processing is commonly used and enables equalizing the contrast and brightness throughout the whole image. Subsequently the image may be viewed with one setting that is more or less optimal for the whole image. The pre-processing method unfortunately induces an extra step in the process from pixel value to display value, and may also introduce extra inaccuracy. If we write the pre-processing as: w(x, y, z)=p(v), where w is the pre-processing intensity and p is a function describing the mapping of v=I(x, y, z) to w, then the LUT mapping becomes:

d(x,y,z)=f(w(x,y,z))=f(p(v))

The following description focuses on an embodiment of the present invention applicable to image analysis and in particular to a location dependent LUT for improving contrast and brightness conditions of an image.

According to some embodiments, parameters are used for calculating the translation from pixel value to display value. These parameters are made local, instead of global image constants, and are adapted to local image content. The result of the translation is not stored as a traditional lookup table, but the parameters are stored as a function of image coordinates.

According to a first embodiment the present invention introduces a locally optimized LUT, which is described by a parameterized function, including both the value of the pixel at a particular location and the coordinates of said pixel location. Hence, the locally optimized LUT optimizes the local image content.

In another embodiment of the invention, with respect to a linear LUT, L and H are not constants, but functions depending on the image coordinates: L(x) and H(x) for a 1D image, L(x,y) and H(x,y) for a 2D image and L(x,y,z) and H(x,y,z) for a 3D image. For a 2D image the display value d for a display value range of 0 to 255, at a location (x,y) is calculated according to eqn. 2:

$$d ( x , y ) = f ( v ) = f ( I ( x , y ) ) = 255 \cdot \frac{v ( x , y ) - L ( x , y )}{H ( x , y ) - L ( x , y )} \qquad ( eqn . 2 )$$

To speed up the process of translating v to d, L(x,y) and H(x,y) may be determined and stored in a two-dimensional LUT.

According to another embodiment of the invention L(x,y) and H(x,y) are set to default values, for instance a constant like in the global non-optimized situation, or a default value distribution related to the type of the image that is shown.

According to another embodiment L(x,y) and H(x,y) are determined and adapted interactively by a user, and/or determined or adapted automatically by some process that inspects and analyses the image content.

The parameterized function of embodiments of the invention may be any parameterized function suited for calculating the display value d from a pixel value v. A parameter might for instance be the highest pixel value in the image, which may be used to determine the value of H, for the linear LUT example above, or it may be the average pixel value M for determining the desired L and H values, etc.

FIG. 4 illustrates a 2D image and a vertical arrow representing the value of a global parameterized function that is required for calculating the display value from the pixel value. The global parameterized function represents the average pixel value, and the value of M, mentioned above, is chosen equal to this average pixel value. The global parameters L and H for determining a linear lookup may then be determined by taking an offset from M.

The value of the global parameter in FIG. 4 can also be illustrated as a plane parallel to the image, according to FIG. 5. The height position of the plane over the image represents the value of the parameter, which is constant for each pixel of the image in the case of a global parameter.

Another embodiment of the invention, according to FIG. 6, illustrates the location dependent parameterized function approach. The value of the parameter is determined at a limited number of different positions of the image represented by M(i,j), i=1, . . . , n, j=1, . . . , n. The magnitude of M(i,j) is illustrated by the vertical arrows of said different positions in FIG. 6.

In another embodiment of the invention, according to FIG. 7, the values for each pixel between the selected pixel positions M(i,j) of the image are derived from the values M(ij). FIG. 7 illustrates a parameterized function (plane), which is tangential to the selected points M(i,j) of FIG. 6. The entire plane consists of triangulated linear planes between the selected points M(i,j), and M(i,j) is recalculated into the parameterized function M(x,y), containing the new pixel values for all pixels with the image.

In yet another embodiment of the invention, according to FIG. 8, a smooth parameterized function with first and second order continuity is arranged tangential to the values of the selected points M(i,j).

In another embodiment of the invention any known or yet unknown interpolation method may be used to create the parameterized function based on the selected points, areas or structures. There is no restriction for the parameterized function, at the position of the selected points, to be equal to said values of said selected points. The values of the selected points is only indicative of the values of the resulting parameterized function and the interpolation method used may alter the resulting values of the parameterized function.

In another embodiment of the invention the selected positions, from which the parameterized function is determined, may be chosen interactively by a user, by pointing at interesting structures or areas in the image, or may be determined automatically based on local image properties such as contrast, variance or any other image property.

According to a further embodiment the conversion from pixel value to display element value may be written as: d(x,y,z)=ƒ(v,x,y,z), where the function ƒ(v,x,y,z) may be any function, for instance a simple space invariant LUT multiplied by a location dependent multiplication factor, according to eqn 3.

d(x,y,z)=f(v,x,y,z)=f′(v)*q(x,y,z) (eqn. 3)

In eqn. 3 f′(v) is a ‘normal’ LUT, based only on the local pixel value and q(x, y, z) is a location dependent multiplication factor.

According to yet another embodiment a location dependent term is added according to eqn. 4.

d(x,y,z)=f(v,x,y,z)=f″(v)*q(x,y,z)+r(x,y,z) (eqn. 4)

According to yet another embodiment ƒ(v, x, y, z) is any 4 dimensional function.

In another embodiment of the invention the function ƒ(v, x, y, z) is defined by a user simply points at a number of locations in the image, resulting in the automatic calculation of ƒ(v, x, y, z) which includes the value of the pixel at a the pointed location, the coordinates of said location and an additional interpolation function for points in between said pointed locations. Thus the calculated LUT will be optimized for each of the selected locations and smoothly varying in between.

According to another embodiment, the method of the invention further comprises calculating a location dependent LUT based on the parameterized function of the invention.

Another embodiment of the invention, according to FIG. 9, illustrates a comparing example of a 2D image of the human blood vessels from the aorta down to the feet. FIG. 9a describes an image, with a non-location dependent LUT wherein the small vessels in the feet are clearly visible, while the large vessels at the top of the image, such as the aorta, are less optimally displayed with several undesired structures. When applying another non-location dependent LUT, illustrated by FIG. 9b, these undesired structures are eliminated and a good view of the aorta is achieved. However, applying the non-location dependent LUT, affects the entire image and thus many of the vessels further down in the direction of the feet become less visible or even disappear completely.

FIG. 9c illustrates the image of FIGS. 9a and 9b, according to the embodiment of the method of the invention, applied with a locally optimized LUT, which provides optimal visibility of the vessels everywhere in the image, and at the same time.

The method of some embodiments of the present invention allows for making a function for every parameter needed to transform a pixel value v into a display value d. Some parameters need to be extracted from the image information, others may be derived from these and others may be set by the user. An important aspect is that the display value is calculated from the pixel value, using parameters that may have a different value for every position in the image.

If the user indicates interesting positions interactively, the invention further makes it possible to update the selection of positions continuously by deleting or repositioning earlier indicated positions and adding new ones, based on what is visually inspected in the displayed image that reflects the changes real-time.

Applications and use of the above-described method according to the invention are various and include exemplary fields such as all areas of imaging.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different types of parameterized functions than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An image processing method for improving image viewing properties of a digital image, comprising converting a value of a property of at least one pixel of the image into a display value of the at least one pixel of the image by means of a parameterized function, wherein the parameterized function is location dependent with reference to the location of said at least one pixel of the image, thus creating locally optimized image viewing properties of the image.

2. The method according to claim 1, comprising applying the location dependent parameterized function on said image, converting each pixel value of said image into a display value, and thus creating a displayed image with optimal viewing properties.

3. The method according to claim 1, wherein the location dependent parameterized function is described as d(x, y, z)=ƒ(v, x, y, z), wherein v is the pixel value at a the position x,y,z thereof in 3D and d is the display value.

4. The method according to claim 3, wherein the location dependent parameterized function is defined by d(x, y, z)=ƒ(v, x, y, z)=ƒ′(v)*q(x, y, z), in which ƒ′(v) is a look-up table (LUT) based only on the local pixel value, and q(x, y, z) is a location dependent multiplication factor.

5. The method according to claim 1, wherein the parameterized function is related to selected pixel positions of said image.

6. The method according to claim 5, comprising selecting the pixels at the selected pixels positions.

7. The method according to claim 6, wherein the selected pixels are automatically selected by means of the image information.

8. The method according to claim 1, in which the parameters of the parameterized function is stored in a look up table (LUT).

9. The method according to claim 1, wherein the resulting optimal image viewing properties relates to contrast, brightness of variance.

10. The method according to claim 1, wherein the image is a medical image.

11. An image processing apparatus, said apparatus being adapted to improve image viewing properties of a digital image, comprising means for converting a value of a property of at least one pixel of the image into a display value of the at least one pixel of the image by means of a parameterized function, wherein the parameterized function is location dependent with reference to the location of said at least one pixel of the image, thus creating locally optimized image viewing properties of the image.

12. The image processing apparatus according to claim 11, wherein the apparatus is a medical workstation.

13. A computer-readable medium having embodied thereon an image processing computer program for processing by a computer, the computer program comprising code segments for improving image viewing properties of a digital image comprising a first code segment converting a value of a property of at least one pixel of the image into a display value of the at least one pixel of the image by means of a parameterized function, wherein the parameterized function is location dependent with reference to the location of said at least one pixel of the image, creating locally optimized image viewing properties of the image.
